(19) United States
(12) Patent Application Publication
(10) Pub. No.: US 2026/0175151 A1
(43) Pub. Date: Jun. 25, 2026

(54) FILTRATION SYSTEM

(71) Applicant: MITSUBISHI KAKOKI KAISHA, LTD., Kanagawa (JP)

(72) Inventors: Nobuyuki TAKAHASHI, Kanagawa (JP); Takuya SUGIUCHI, Kanagawa (JP)

(73) Assignee: MITSUBISHI KAKOKI KAISHA, LTD., Kanagawa (JP)

(21) Appl. No.: 19/124,298

(22) PCT Filed: Sep. 19, 2023
(86) PCT No.: PCT/JP2023/033940

§ 371 Date: Apr. 25, 2025

(30) Foreign Application Priority Data
Oct. 28, 2022 (JP) 2022-173319

(51) Int. Cl. B01D 37/04; B01D 39/00

(52) U.S. Cl. CPC B01D 37/04; B01D 39/00; B01D 2201/08

(57) ABSTRACT

A filtration system including: an imaging unit disposed on a path of a fluid in the filtration unit and configured to acquire image data of the fluid; a determination unit configured to determine a state of the treatment unit based on the image data; and an output unit configured to output a control signal for the treatment unit based on a determination result of the state of the treatment unit, in which the determination unit determines a treatment state of the filtration unit, a deterioration state of the filter media, or an abnormal state of the filter media by using a determination model that is machine-learned using the image data as input data and using the treatment state of the filtration unit, the deterioration state of the filter media, or the abnormal state of the filter media as output data.

### TECHNICAL FIELD

The present invention relates to a filtration system capable of automatically controlling a treatment unit for filtering a slurry liquid.

### BACKGROUND ART

To continuously operate a filtration device, it is important to accurately understand a state of filter media such as a filtration membrane, a filter, a filter paper, or a filter cloth.

Filtration performance of filter media decreases due to adhesion of a substance to be separated to a surface of the filter media or inside of the filter media by repeated filtration. In addition, when damage or the like occurs due to deterioration of the filter media, a quality of a product such as filtrate or cake is reduced. In the related art, a state of the filter media is managed through a visual check by an operator, time settings, or the like. Therefore, a technique for managing the state of the filter media has been provided.

Patent Literature 1 discloses an oil state monitoring method and an oil state monitoring device capable of accurately monitoring a state of oil to appropriately predict a lifespan of oil used in various machines or facilities. Patent Literature 1 discloses that an oil deterioration state is monitored by filtering the oil, projecting light onto a filter that removes the oil, and detecting a color component of transmitted light.

Patent Literature 2 discloses an important factor calculation device that accurately predicts an important factor that causes fouling of a filtration membrane. Patent Literature 2 discloses that a predictor that predicts filtration performance of a filtration membrane after a unit time step is trained from time series data of a plurality of parameters including a parameter indicating the filtration performance of the filtration membrane and a parameter indicating a water quality of a wastewater treatment unit in which the filtration membrane is used, and a parameter that contributes to prediction of the filtration performance after a unit time step from a prediction period is output.

Patent Literature 3 discloses a technique for achieving an appropriate operation control of a centrifugal separation system without depending on a determination of an operator. Patent Literature 3 discloses that there is provided a training dataset storage unit 22 that stores a plurality of training datasets each including input data, which includes image data obtained by capturing an image of a separated liquid from a predetermined angle of view, and output data, which is associated with the input data and includes a control parameter including at least one of a supply amount of an additive added to a liquid to be treated PL1, a centrifugal force of a bowl 2, or a differential speed controlled by a differential speed generation device 5, a training unit 23 that trains a training model for inferring a correlation between the input data and the output data by inputting the plurality of training datasets, and a trained model storage unit 24 that stores the learned trained model.

According to Patent Literature 3, it is understood that a control in a centrifugal separator is automated, which is effective in eliminating operational load, improving productivity, and the like.

### CITATION LIST

### Patent Literature

Patent Literature 1: JP5190660B
Patent Literature 2: WO2022/085802
Patent Literature 3: JP2022-021243A

### SUMMARY OF INVENTION

### Technical Problem

An object of the present invention is to provide a filtration system capable of automatically controlling, by artificial intelligence (AI), a treatment unit for filtering a slurry liquid.

### Solution to Problem

To solve the above problem, the present invention provides a filtration system capable of automatically controlling a treatment unit for filtering a slurry liquid, the treatment unit including a filtration unit, the filtration system including: an imaging unit disposed on a path of a fluid in the filtration unit and configured to acquire image data of the fluid; a determination unit configured to determine a state of the treatment unit based on the image data; and an output unit configured to output a control signal for the treatment unit based on a determination result of the state of the treatment unit, in which the state of the treatment unit includes a treatment state of the filtration unit, a deterioration state of filter media, or an abnormal state of the filter media, and the determination unit determines a treatment state of the filtration unit, a deterioration state of the filter media, or an abnormal state of the filter media by using a determination model that is machine-learned using the image data as input data and using the treatment state of the filtration unit, the deterioration state of the filter media, or the abnormal state of the filter media as output data.

As described above, by using the machine-learned model in the filtration device, the treatment state of the filtration unit, the deterioration state of the filter media, and the abnormal state of the filter media can be determined from the image data of the fluid, and the treatment unit can be automatically controlled according to these states. Equipped with artificial intelligence (AI), the filtration device can automatically determine a determination criterion related to the state of the treatment unit, which was previously determined by an operator based on experience, and thus an appropriate automatic control of the treatment unit according to the state can be achieved without requiring an operation by the operator.

Further, the present invention provides a filtration system capable of automatically controlling a treatment unit for filtering a slurry liquid, the treatment unit including a cleaning unit, the filtration system including: an imaging unit disposed on a path of a fluid in the cleaning unit and configured to acquire image data of the fluid; a determination unit configured to determine a state of the treatment unit based on the image data; and an output unit configured to output a control signal for the treatment unit based on a determination result of the state of the treatment unit, in which the state of the treatment unit includes a treatment state of the cleaning unit, a deterioration state of filter media, or an abnormal state of the filter media, and the determination unit determines a treatment state of the cleaning unit, a deterioration state of the filter media, or an abnormal state of the filter media by using a determination model that is machine-learned using the image data as input data and using the treatment state of the cleaning unit, the deterioration state of the filter media, or the abnormal state of the filter media as output data.

As described above, by using the machine-learned model in the filtration device, the treatment state of the cleaning unit, the deterioration state of the filter media, and the abnormal state of the filter media can be determined from the image data of the fluid, and the treatment unit can be automatically controlled according to these states. Equipped with artificial intelligence (AI), the filtration device can automatically determine a determination criterion related to the state of the treatment unit, which was previously determined by an operator based on experience, and thus an appropriate automatic control of the treatment unit according to the state can be achieved without requiring an operation by the operator.

In a preferred embodiment of the present invention, the treatment unit includes the filtration unit, the fluid is filtrate, the determination unit determines a treatment state of the filtration unit, and the output unit outputs a control signal for the filtration unit based on a determination result of the treatment state of the filtration unit.

In a preferred embodiment of the present invention, the control signal for the filtration unit includes at least any one or more of a control signal related to an operation of the filtration unit, a control signal related to a supply amount of the slurry liquid, a control signal related to a deliquoring treatment, or a control signal related to a supply amount of a filtration aid liquid.

In a preferred embodiment of the present invention, the control signal for the filtration unit is a control signal for increasing or decreasing an internal pressure of a filter chamber on at least any one of a supply path side or a discharge path side.

In a preferred embodiment of the present invention, the control signal for the filtration unit is a control signal for changing an opening and closing time of a supply valve for the slurry liquid or a filtration aid liquid.

With such a configuration, the treatment state of the filtration unit can be determined, and an appropriate automatic control according to each state can be achieved.

In a preferred embodiment of the present invention, the treatment unit includes the cleaning unit, the fluid is cleaning effluent, the determination unit determines a treatment state of the cleaning unit, and the output unit outputs a control signal for the cleaning unit based on a determination result of the treatment state of the cleaning unit.

With such a configuration, the treatment state of the cleaning unit can be determined, and an appropriate automatic control according to the state can be achieved.

In a preferred embodiment of the present invention, the treatment unit includes the filtration unit, a cleaning unit, a replacement unit, or a warning notification unit, the fluid is filtrate, the determination unit determines a deterioration state of filter media, and the output unit outputs at least any one or more of a control signal for the cleaning unit, a control signal for the replacement unit, or a warning signal for the warning notification unit based on a determination result of the deterioration state of the filter media.

In a preferred embodiment of the present invention, the treatment unit includes the cleaning unit, a replacement unit, or a warning notification unit, the fluid is cleaning effluent, the determination unit determines a deterioration state of the filter media, and the output unit outputs at least any one or more of a control signal for the cleaning unit, a control signal for the replacement unit, or a warning signal for the warning notification unit based on a determination result of the deterioration state of the filter media.

With such a configuration, the deterioration state of the filter media can be determined, and an appropriate automatic control according to the state can be achieved.

In a preferred embodiment of the present invention, the treatment unit includes the filtration unit, the cleaning unit, or a warning notification unit, the fluid is filtrate or cleaning effluent, the determination unit determines an abnormal state of the filter media, and the output unit outputs a control signal related to an operation to the filtration unit or outputs a warning signal related to the abnormal state of the filter media to the warning notification unit, based on a determination result of the abnormal state of the filter media.

With such a configuration, the abnormal state of the filter media can be determined, and a response to the abnormal state can be quickly made.

In a preferred embodiment of the present invention, the treatment unit includes the filtration unit, the fluid is the slurry liquid, the imaging unit is disposed on a supply path of the slurry liquid and acquires image data of the slurry liquid, and the output unit outputs a control signal related to a supply amount of a filtration aid liquid to the filtration unit based on a determination result of the treatment state of the filtration unit.

With such a configuration, the supply amount of the filtration aid liquid can be appropriately controlled according to a state of the slurry liquid.

In a preferred embodiment of the present invention, the imaging unit is disposed on the path of the fluid at an angle of view that is substantially horizontal with respect to a horizontal plane.

With such a configuration, a liquid level, a liquid amount, and the like of the fluid can be imaged at an appropriate angle of view, and accuracy of determination can be improved.

In a preferred embodiment of the present invention, the filtration system further including: a control mode switching unit configured to switch a treatment unit to be controlled, in which the treatment unit includes the filtration unit, the cleaning unit, and a replacement unit, the determination unit determines a state of the treatment unit including the treatment state of the filtration unit, the treatment state of the cleaning unit, and the deterioration state of the filter media, the output unit outputs a control signal for the filtration unit, the cleaning unit, and the replacement unit based on a determination result of the state of the treatment unit, and the control mode switching unit switches a control mode based on the determination result of the state of the treatment unit or an output of the control signal.

In a preferred embodiment of the present invention, the treatment unit includes a warning notification unit, the determination unit further determines a state of the treatment unit including the abnormal state of the filter media, and the output unit outputs a warning signal corresponding to the control mode to the warning notification unit based on a determination result of the deterioration state of the filter media or the abnormal state of the filter media.

With such a configuration, a series of operations in the filtration device including the filtration unit, the cleaning unit, and the replacement unit can be automatically controlled.

In a preferred embodiment of the present invention, a filtrate discharge path of the filtration unit also serves as a cleaning effluent discharge path of the cleaning unit, and the imaging unit is disposed in the filtrate discharge path.

With such a configuration, operations of the filtration device including the filtration unit and the cleaning unit can be automatically controlled by disposing one imaging unit.

### Advantageous Effects of Invention

According to the present invention, a filtration system capable of automatically controlling, by artificial intelligence (AI), a treatment unit for filtering a slurry liquid can be provided.

### BRIEF DESCRIPTION OF DRAWINGS

FIG. 1 illustrates a block diagram of a filtration system according to the present embodiment.

FIG. 2 illustrates schematic diagrams of the filtration system according to the present embodiment.

FIG. 3 illustrates a schematic diagram of the filtration system according to the present embodiment.

FIG. 4 illustrates a schematic diagram of an imaging unit according to the present embodiment.

FIG. 5 illustrates a schematic diagram of the imaging unit according to the present embodiment.

FIG. 6 illustrates examples of image data acquired by the imaging unit according to the present embodiment.

FIG. 7 illustrates a block diagram of a model generation device according to the present embodiment.

FIG. 8 illustrates a configuration example of a determination model according to the present embodiment.

FIG. 9 illustrates configuration examples of datasets according to the present embodiment.

FIG. 10 illustrates a flowchart of machine learning processing according to the present embodiment.

FIG. 11 illustrates a configuration example of a control signal table according to the present embodiment.

FIG. 12 illustrates each step in the filtration system according to the present embodiment.

FIG. 13 illustrates a block diagram of a filtration system according to Embodiment 2.

FIG. 14 illustrates each step in a filtration device in the related art.

### DESCRIPTION OF EMBODIMENTS

Hereinafter, a filtration system according to the present invention will be described with reference to the drawings. The embodiments described below are examples of the present invention, and the present invention is not limited to the embodiments described below, and various configurations can be used.

A filtration device separates a slurry liquid, which is a solid-liquid mixed liquid to be filtered, into cake and filtrate, which are solid products, by passing the slurry liquid through filter media such as a filtration membrane, a filter, a filter paper, or a filter cloth.

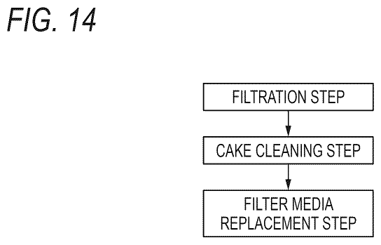

FIG. 14 illustrates each treatment step using a filtration device in the related art.

A filtration step is a step in which a slurry liquid is filtered and separated into cake and filtrate. In the filtration step, an operator performs operations on the filtration device, such as starting filtration, setting and adjusting a supply amount of the slurry liquid, setting and adjusting a pressure of a filter chamber, and ending the filtration. The filtration step may include a deliquoring step of performing a cake deliquoring treatment. In the deliquoring step, the operator performs operations on the filtration device, such as starting deliquoring, setting and adjusting a pressure of the filter chamber, and ending the deliquoring.

A cake cleaning step is a step in which after the filtration ends, a cleaning liquid is supplied to the filter chamber to clean the cake. In the cake cleaning step, the operator performs operations on the filtration device, such as starting cake cleaning, setting and adjusting a supply amount of the cleaning liquid, setting and adjusting a pressure of the filter chamber, and ending the cleaning.

A filter media replacement step is a step in which the filter media is cleaned or replaced when deterioration (for example, fouling) occurs in the filter media or when an abnormality (for example, filter media damage or filtration leakage) occurs in the filter media. In the filter media replacement step, the operator performs operations such as starting the filter media cleaning or filter media replacement and ending the filter media replacement. When the filter media replacement step is not performed using an automatic filtration device, opening the filter chamber, installing the filter media, closing the filter chamber, and the like are manually performed. In the filter media replacement step, the cake deposited on the filter media is discharged.

When the filter media replacement is completed in the filter media replacement step, the processing returns to the filtration step and is repeated.

In the above treatment step, the operator visually checks a state of the filtrate and a state of the cleaning effluent and determines whether to end the filtration or the cleaning. Alternatively, the operator manages each step by setting a filtration time and a cleaning time with a timer. Further, an input amount and an input timing of a filtration aid liquid are also managed through a visual check by the operator and timer settings.

An object of the filtration system of the present invention is to automatically control the filtration step, the cake cleaning step, and the filter media replacement step.

### Embodiment 1

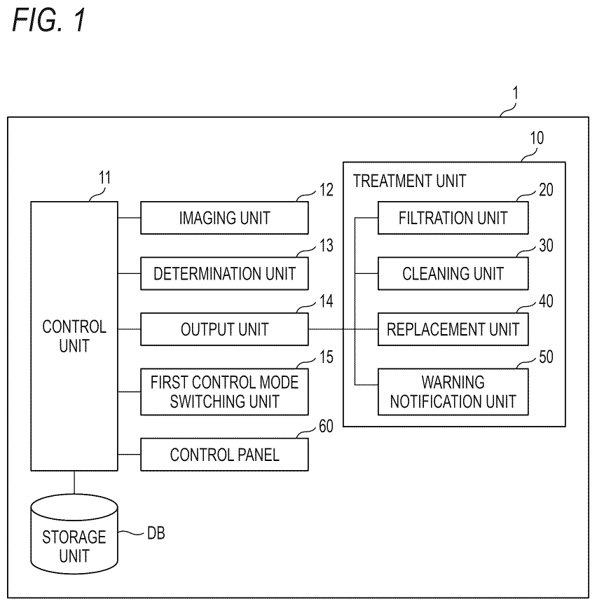

FIG. 1 illustrates a block diagram of a filtration system 1 according to the present embodiment. The filtration system 1 includes a control unit 11, an imaging unit 12, a determination unit 13, an output unit 14, a first control mode switching unit 15, a storage unit DB as a database, and a control panel 60, and each component is connected to and controlled by the control unit 11. The output unit 14 is connected to a treatment unit 10 and controls an operation of the treatment unit 10 by outputting a control signal. The treatment unit 10 includes a filtration unit 20 that controls a filtration step, a cleaning unit 30 that controls a cleaning step, a replacement unit 40 that controls a filter media replacement step, and a warning notification unit 50 that controls a notification on a deterioration state of the filter media (for example, fouling) or an abnormal state of the filter media (for example, filter media damage or filtration leakage). In the present embodiment, the filtration system 1 is configured as a filtration device.

The deterioration state of the filter media includes at least no filter media deterioration and filter media deterioration. The deterioration state of the filter media may further include a degree of gradual deterioration state (such as minor deterioration or major deterioration).

The abnormal state of the filter media includes at least no abnormality and an abnormality. The abnormal state of the filter media may include the filter media damage, the filtration leakage, and the like as types of abnormalities.

The treatment unit 10 illustrates a device configuration that performs treatments including filtration, cake cleaning, device cleaning, filter media replacement, and warning notification in the filtration system 1 (1A to ID). The treatment unit 10 causes the components to operate based on an input of the control signal and achieves various treatments.

The control unit 11 is implemented by an arithmetic device such as a central processing unit (CPU). The control unit 11 may be connected to the treatment unit 10 and control a mechanism based on the control signal. The control unit 11 is connected to the control panel 60 and can receive an operation input via the control panel 60. The control unit 11 may perform display processing on the control panel 60.

The imaging unit 12 is disposed on a fluid path in the filtration device and acquires image data of a fluid.

The determination unit 13 determines a state of the treatment unit 10 based on the image data acquired by the imaging unit 12.

The output unit 14 outputs a control signal for the treatment unit 10 based on a determination result of the state of the treatment unit 10 by the determination unit 13. The treatment unit 10 is controlled based on the control signal output by the output unit 14.

The first control mode switching unit 15 switches a control mode based on the determination result of the state of the treatment unit 10 by the determination unit 13 or an output of the control signal by the output unit 14. The control mode indicates whether the treatment unit 10 to be controlled is the filtration unit 20, the cleaning unit 30, or the replacement unit 40.

The storage unit DB stores a determination model used for determination processing of the image data by the determination unit 13. The storage unit DB stores a control signal table used for determining a control signal to be output by the output unit 14. Further, the storage unit DB stores a program including various data such as image data and various commands to be executed by the control unit 11. The program may be stored and installed in a non-transitory computer-readable recording medium such as a CD-ROM, a flash memory, or an SSD memory.

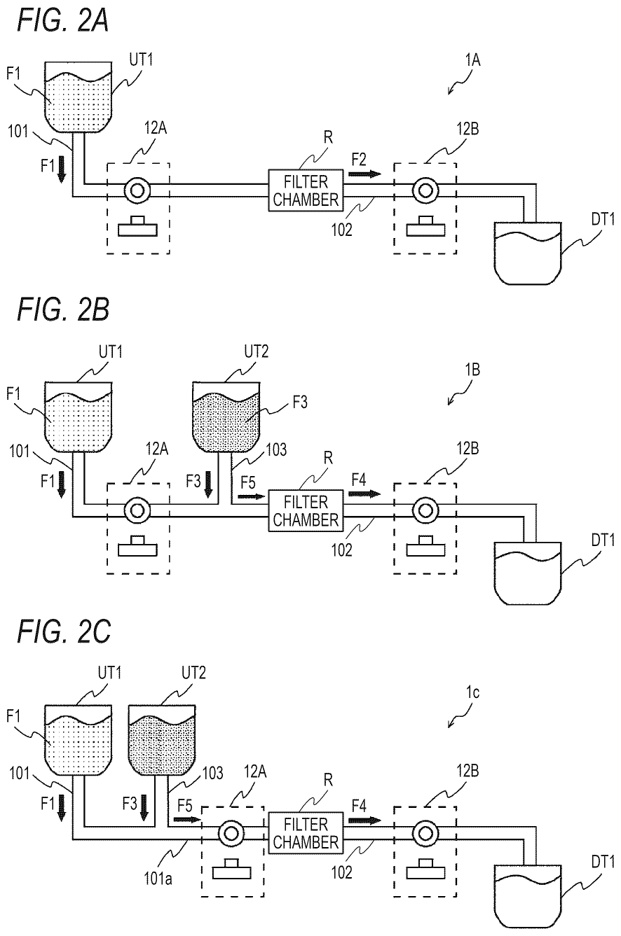

(a), (b), and (c) of FIG. 2 are diagrams illustrating device configurations for controlling filtration steps in the slurry filtration systems 1A to 1C.

As illustrated in (a) of FIG. 2, the filtration unit 20 has a device configuration for controlling the filtration step of the slurry filtration system 1A that filters a slurry liquid F1 in a filter chamber R. The filtration unit 20 includes a first supply tank UT1 that supplies the slurry liquid F1, a supply path 101 that supplies the slurry liquid F1 from the first supply tank UT1 to the filter chamber R, a discharge path 102 that discharges filtrate F2 filtered in the filter chamber R, a first discharge tank DT1 that stores the filtrate F2, a first imaging unit 12A that is interposed in the supply path 101 between the first supply tank UT1 and the filter chamber R and acquires image data of the slurry liquid F1, and a second imaging unit 12B that is interposed in the discharge path 102 between the filter chamber R and the first discharge tank DT1 and acquires image data of the filtrate F2. The slurry filtration system 1A includes a filter chamber pressure control unit (not illustrated).

The first supply tank UT1 includes a supply valve (not illustrated), and a supply amount of the slurry liquid F1 is controlled by an opening and closing time of the supply valve. The filter chamber R includes filter media (not illustrated) between a supply path 101 side and a discharge path 102 side, and performs filtration treatment on the slurry liquid F1 by a differential pressure between the supply path 101 side and the discharge path 102 side.

The filter chamber pressure control unit (not illustrated) is implemented by a pressure pump (not illustrated) or a pressure valve (not illustrated) that controls an internal pressure of the filter chamber R on at least any one of the supply path 101 side or the discharge path 102 side. Further, for example, when a mechanism that performs centrifugal separation by rotating the filter chamber R is used, the filter chamber pressure control unit (not illustrated) is implemented by an actuator (not illustrated) that controls the number of rotations or a rotation speed, or the like. Further, for example, when a mechanism that separates the slurry liquid F1 by compression such as a press is used, the filter chamber pressure control unit (not illustrated) is implemented by an actuator (not illustrated) that controls a press pressure and a press time, or the like.

As illustrated in (b) of FIG. 2, in the slurry filtration system 1B, the filtration unit 20 may supply a filtration aid liquid F3 when the slurry liquid F1 is filtered in the filter chamber R. For the filtration aid liquid F3, a filtration aid liquid supply path 103 that supplies the filtration aid liquid F3 is provided, which connects from a second supply tank UT2 that supplies the filtration aid liquid F3, to the supply path 101. The second supply tank UT2 includes a supply valve (not illustrated), and a supply amount of the filtration aid liquid F3 is controlled by an opening and closing time of the supply valve. The filtration aid liquid supply path 103 for the filtration aid liquid F3 from the second supply tank UT2 to the filter chamber R may be separately provided to supply the filtration aid liquid to the filter chamber R without being connected to the supply path 101 for the slurry liquid F1 from the first supply tank UT1 to the filter chamber R.

The first imaging unit 12A acquires image data of the slurry liquid F1 passing through the supply path 101. The second imaging unit 12B acquires image data of the filtrate F2 passing through the discharge path 102 or filtrate F4 containing the filtration aid liquid F3.

Further, as illustrated in (c) of FIG. 2, in the slurry filtration system 1C, the filtration unit 20 may be configured such that the first imaging unit 12A is disposed in a supply path 101a of a mixed liquid F5 of the slurry liquid F1 and the filtration aid liquid F3 and acquires image data of the mixed liquid F5.

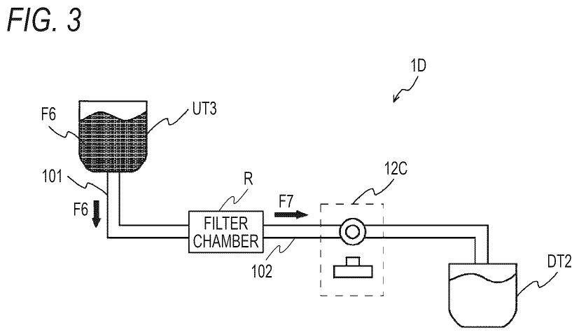

FIG. 3 is a diagram illustrating a device configuration for controlling a cleaning step of the slurry filtration system ID.

As illustrated in FIG. 3, in the slurry filtration system ID, the cleaning unit 30 includes a third supply tank UT3 that supplies a cleaning liquid F6, the filter chamber R, a third imaging unit 12C installed in the discharge path 102, and a second discharge tank DT2 that stores used cleaning effluent F7.

The cleaning unit 30 further includes a filter chamber pressure control unit (not illustrated). The third supply tank UT3 includes a supply valve (not illustrated), and a supply amount of the cleaning liquid is controlled by an opening and closing time of the supply valve. The filter chamber R, the filter chamber pressure control unit (not illustrated), a part of the supply path 101, and a part of the discharge path 102 may have the same configuration as the filtration unit 20.

In addition, in the present embodiment, the cleaning step includes a cake cleaning step of performing cake cleaning and a device cleaning step of performing internal cleaning of the filtration device. The cleaning liquid F6 cleans cake (not illustrated) or the filter chamber R, passes through the discharge path 102 as the cleaning effluent F7, and is discharged to the second discharge tank DT2.

The replacement unit 40 illustrates a device configuration for controlling the filter media replacement step of the filtration system 1. The replacement unit 40 includes replacement filter media, a replacement filter media rack that accommodates the replacement filter media, a filter media supply mechanism that supplies the replacement filter media from the replacement filter media rack to the filter chamber, a filter media discharge mechanism that discharges the used filter media from the filter chamber, and a filter media cleaning mechanism for cleaning the filter media.

The warning notification unit 50 illustrates a configuration for controlling a warning notification related to a deterioration state of the filter media and an abnormal state of the filter media in the filtration system 1. The warning notification unit 50 is connected to the control panel 60 and displays the warning notification on a display. Further, the warning notification unit 50 may include an alarm or a lamp, and may be configured to output the warning notification as a voice, an alarm sound, or lighting or blinking of the lamp.

In the present embodiment, the filtration system 1 may be configured such that at least one unit selected from the filtration unit 20, the cleaning unit 30, the replacement unit 40, or the warning notification unit 50 is automated. The filtration system 1 may have a configuration including, a treatment unit including the filtration unit 20 and the cleaning unit 30, and not including the replacement unit 40.

The control panel 60 is configured as a touch panel or the like that functions as a display unit and an input unit. The control panel 60 may include a display as a display unit that displays a state and the like of the filtration system 1, and an operation panel as an input unit that operates the filtration system 1. The control panel 60 may be configured as a computer terminal that is externally connected to the filtration system 1. The input unit of the control panel 60 receives an input of operation information and transmits the operation information to the control unit 11, and the control unit 11 controls each component based on the received operation information.

Here, the second imaging unit 12B and the third imaging unit 12C are disposed in the filtrate discharge path and the cleaning effluent discharge path, respectively. When the filtrate discharge path of the filtration unit 20 also serves as the cleaning liquid discharge path of the cleaning unit 30, at least any one of the second imaging unit 12B or the third imaging unit 12C may be disposed in the filtrate discharge path. That is, the second imaging unit 12B (third imaging unit 12C) monitors the two fluids, that is the filtrate and the cleaning effluent, and acquires image data thereof.

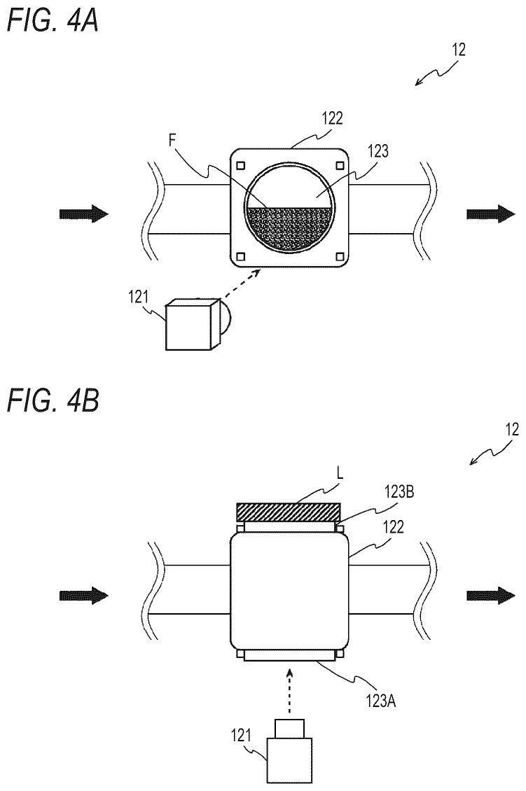

FIG. 4 illustrates a schematic diagram of the imaging unit 12. (a) of FIG. 4 illustrates a front view of the imaging unit 12. (b) of FIG. 4 illustrates a top view of the imaging unit 12.

As illustrated in (a) of FIG. 4, the imaging unit 12 includes an imaging module 121 such as a camera, a sight glass 122, and a window 123 provided in the sight glass 122. The imaging module 121 is disposed facing the window 123 (dotted arrow) and acquires image data of a fluid F flowing inside the path. The imaging module 121 is connected to the control unit 11. (a) of FIG. 4 illustrates an example of a horizontal pipe in which the fluid F passes through the pipe provided on left and right sides of the sight glass 122 from a left direction to a right direction. However, a position and a direction of the pipe provided in the sight glass 122 are not limited thereto.

The imaging unit 12 is disposed, for example, at an angle of view that is substantially horizontal with respect to a horizontal plane. The term “substantially horizontal” refers to an angle of view of −20 degrees to +20 degrees with respect to the horizontal plane, preferably an angle of view of −10 degrees to +10 degrees, and more preferably an angle of view of −5 degrees to +5 degrees. In the present embodiment, the fluid F is a liquid, and it is preferable to dispose the imaging unit 12 capable of acquiring image data including features such as a liquid surface and a flow rate.

The imaging unit 12 preferably further includes a reference light source L. The light source L is provided for a purpose of keeping a light amount in a surrounding environment of the imaging unit 12 constant. Since the light amount in the surrounding environment affects an appearance of a color of the fluid imaged by the imaging module 121, accuracy of determination based on the color can be improved by keeping the light amount during imaging constant. The imaging unit 12 may be provided with a cover or the like for blocking external light with respect to the imaging module 121 and the sight glass 122. As a disposition example of the light source L, as illustrated in (b) of FIG. 4, the sight glass 122 includes a window 123B on a back surface, and the reference light source L can be provided as a backlight to cover the window 123B. The light source L may be provided to irradiate a window 123A on a front surface at a predetermined angle.

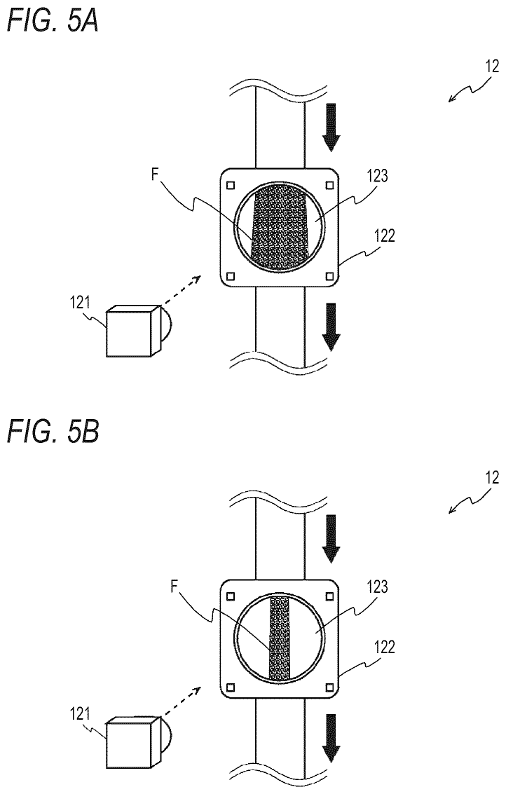

FIG. 5 illustrates a schematic diagram of the imaging unit 12 in a case of a vertical pipe. In FIG. 5, the fluid F passes through the pipe provided above and below the sight glass 122 from an up direction to a down direction. In particular, the imaging units 12B and 12C disposed in the discharge path from the filter chamber R (not illustrated) can acquire image data indicating a tendency of an increase or a decrease in a liquid amount of the fluid F by using the vertical pipe. For example, as illustrated in (a) of FIG. 5, the liquid amount of the fluid F tends to increase relatively at an initial stage of discharge of the fluid F from the filter chamber R because the internal pressure of the filter chamber is low.

On the other hand, as illustrated in (b) of FIG. 5, the liquid amount of the fluid F tends to decrease relatively because the internal pressure of the filter chamber increases as the discharge progresses. The imaging units 12B and 12C are preferably provided within a range of 10 m from the filter chamber R, and more preferably provided within a range of 5 m from the filter chamber R. Further, the imaging units 12B and 12C are preferably provided immediately below the filter chamber R.

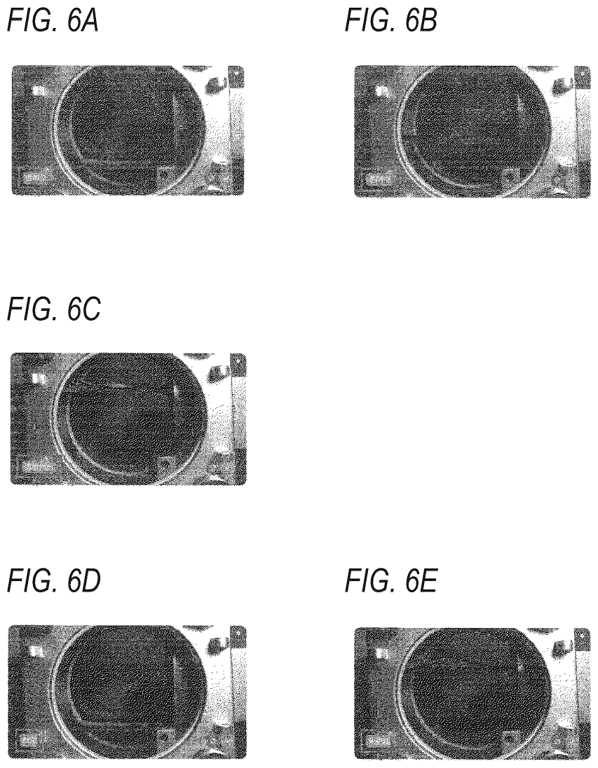

FIG. 6 illustrates examples of image data of the fluid F acquired by the imaging unit 12. (a) to (c) of FIG. 6 illustrate image data of a transparent fluid F. (d) and (e) of FIG. 6 illustrate image data of a colored fluid F. The determination unit 13 can extract a feature included in the image data and determine a state of the treatment unit 10.

The image data in (a) to (c) of FIG. 6 illustrate states in which amounts of the transparent fluid F are different. The image data in (d) and (e) of FIG. 6 illustrate states in which amounts of the colored fluid F are different. The determination unit 13 can determine a state of the treatment unit 10 from features of the different states of the fluid F.

Test results of the determination in which the image data in (a) to (e) of FIG. 6 (referred to as image A to image E) are input to the determination model are “image A: transparent, empty”, “image B: transparent, medium”, “image C: transparent, supplied”, “image D: colored, empty”, and “image E: colored, supplied”. From these results, it is understood that the determination unit 13 using the determination model can extract the features of the amount and the color of the fluid F. The determination model can further determine the amount of the fluid F in a stepwise manner, and can further determine a brightness, a luminance, a concentration, and a color value related to the color of the fluid F in a stepwise manner.

Although FIG. 6 illustrates examples of image data in which the fluid F passes through the horizontal pipe, the image data may be image data in which the fluid F passes through the vertical pipe as illustrated in FIG. 5. In the present embodiment, the position and the direction of the pipe are not limited as long as the image data can extract features including at least the amount and the color of the fluid F.

The determination unit 13 can determine the state of the treatment unit 10 of the filtration system 1 based on the features in the image data of the fluid F as described above.

In the present embodiment, the state of the treatment unit 10 includes a treatment state of the filtration unit 20, a treatment state of the cleaning unit 30, a deterioration state of the filter media, and an abnormal state of the filter media.

The treatment state of the filtration unit 20 includes a filtration treatment state and a deliquoring treatment state. The filtration treatment state includes pre-filtration, filtration in progress, filtration complete, slurry liquid shortage, slurry liquid excess, filtration aid liquid shortage, filtration aid liquid excess, and the like. The filtration treatment state may include an insufficient amount or an excessive amount of the slurry liquid or the filtration aid liquid. The deliquoring treatment state includes pre-deliquoring, deliquoring in progress, deliquoring complete, and the like.

The treatment state of the cleaning unit 30 includes a cake cleaning treatment state, a device cleaning treatment state, a filter media cleaning treatment state, and a deliquoring treatment state depending on a cleaning target, and the treatment state is determined for each cleaning target. The treatment state of the cleaning unit 30 includes pre-cleaning, cleaning in progress, cleaning complete, cleaning liquid shortage, cleaning liquid excess, and the like. The treatment state of the cleaning unit 30 may include an insufficient amount or an excessive amount of the cleaning liquid.

The deliquoring treatment state indicates a filtrate deliquoring state in the cake in the treatment state of the filtration unit 20, and indicates a cleaning liquid deliquoring state in the cake in the treatment state of the cleaning unit 30.

As a specific example, when the fluid F in the image data is image data of the filtrate, a stable flow of the filtrate is observed when a filtration state is stable, and a decrease in the filtrate is observed due to an accumulation of a filtration cake, and thus the determination unit 13 can determine a treatment state related to a progress of the filtration. Further, since an amount of the filtrate decreases according to deterioration of the filter media (fouling or the like), the determination unit 13 can determine a deterioration state of the filter media. When the fluid F in the image data is image data of the cleaning effluent, transparency of a color of the cleaning effluent increases as the cleaning proceeds, and thus the determination unit 13 can determine a treatment state related to a progress of the cleaning.

In the present embodiment, the determination unit 13 determines the state of the treatment unit 10 using a determination model stored in the storage unit DB. The determination model indicates a trained model that has been machine-learned using a dataset. The determination model is generated by an external model generation device 7 and stored in the storage unit DB.

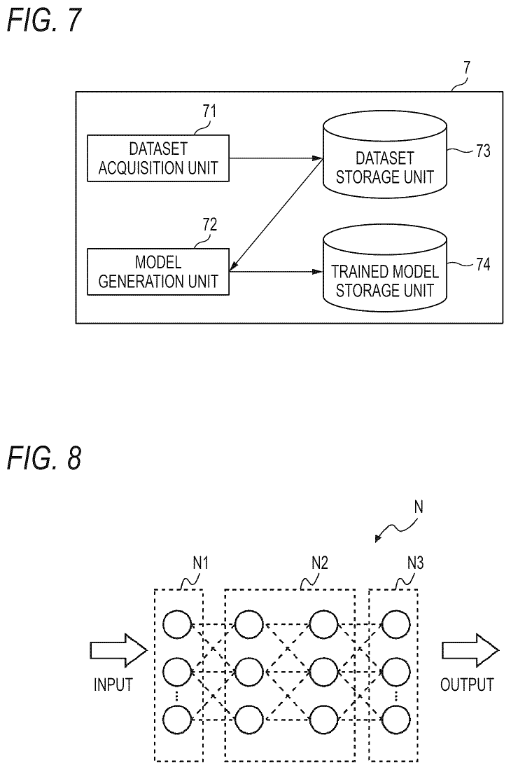

FIG. 7 illustrates a block diagram of the model generation device 7 that performs determination model generation processing. The model generation device 7 includes a dataset acquisition unit 71, a model generation unit 72, a dataset storage unit 73, and a model storage unit 74. The dataset acquisition unit 71 is preferably configured to acquire image data acquired by the imaging unit 12 illustrated in FIG. 3 as a dataset.

The model generation device 7 may be a general-purpose computer. The model generation device 7 includes, as hardware components, an arithmetic device such as a CPU, a main storage device such as a RAM, an auxiliary storage device, a communication device, an input and output device, and the like.

The filtration system 1 and the model generation device 7 are configured to be capable of wired or wireless data communication. In addition, a filtration system including the filtration system 1 and the model generation device 7 may be configured. The filtration system 1 may include the functional components (71-74) of the model generation device 7.

In the present embodiment, an algorithm of machine learning may use a neural network. As illustrated in FIG. 8, the neural network N includes an input layer N1, an intermediate layer N2, and an output layer N3. Each layer consists of a plurality of neurons each having an activation function. The input layer N1 receives an input of input data of a dataset. The input layer N1 consists of a plurality of neurons corresponding to input data, and outputs a calculation result for the input data to the intermediate layer N2. The intermediate layer N2 consists of one or more layers and includes a plurality of neurons in each layer. The intermediate layer N2 receives an input of a calculation result from the input layer N1, and further outputs the calculation result for the input to the adjacent layer in the intermediate layer N2 or the output layer N3. The output layer N3 outputs an estimated value according to an input from the intermediate layer N2. By adjusting a coefficient of each neuron to reduce an error between the estimated value of the output layer N3 and output data of the dataset, determination accuracy of the output data with respect to the input data can be improved.

The algorithm of the machine learning is not limited to the neural network, and a regression analysis model, a support vector machine, a k-nearest neighbor algorithm, a decision tree model, or the like may be used.

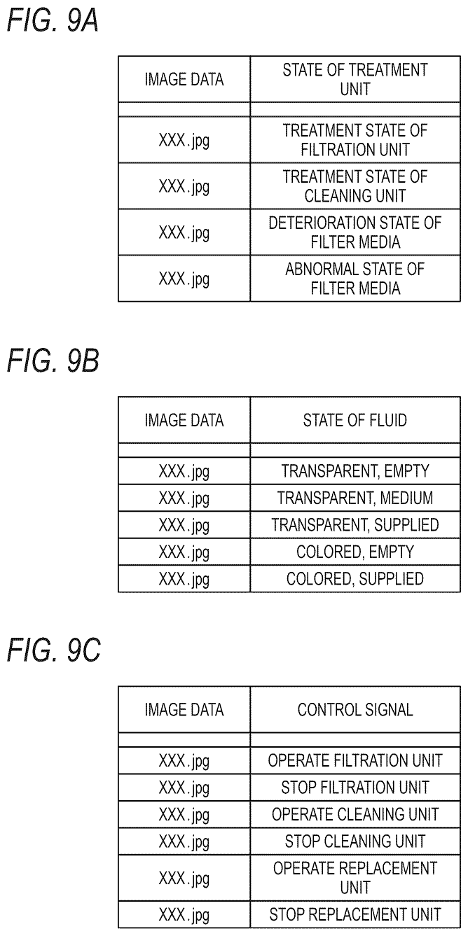

FIG. 9 illustrates configuration examples of datasets used for machine learning of the determination model.

In the present embodiment, as illustrated in (a) of FIG. 9, the dataset is configured using the image data as input data and the state of the treatment unit 10 as output data.

As illustrated in (b) of FIG. 9, the dataset may be configured using the image data as input data and the state of the fluid as output data. The state of the fluid includes states such as an amount and a color of the fluid F.

As illustrated in (c) of FIG. 9, the dataset may be configured using the image data as input data and the control signal for the treatment unit as output data. The control signal is a signal output from the output unit 14 to the treatment unit 10, and indicates a signal corresponding to a control for each of the filtration unit 20, the cleaning unit 30, the replacement unit 40, and the warning notification unit 50.

In the present embodiment, the dataset may be configured using a combination of a plurality of pieces of image data in time series as input data, and at least one selected from the state of the treatment unit 10, the state of the fluid, or the control signal for the treatment unit as output data. The determination model, which is machine-learned using a combination of image data in a time series as input data, can output data corresponding to a change in image data by receiving an input of image data in an order of the combination.

At this time, the output data may correspond to a time series (time difference) of the plurality of pieces of image data, and may be configured as at least one piece of data selected from the state of the treatment unit 10 after a predetermined time has elapsed, the state of the fluid, or the control signal for the treatment unit. For the dataset, for example, when image data for every five seconds is used as input data, the determination model can output a predicted value of the state of the treatment unit 10 as a determination result by using the state of the treatment unit 10 after five seconds as output data. By using the above determination model, the determination unit 13 can correct a time lag and control the treatment unit 10 even when a time lag occurs from acquisition of image data to control of the treatment unit 10.

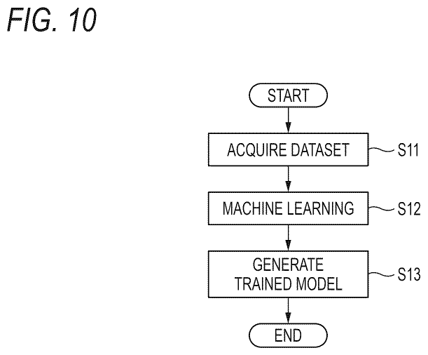

FIG. 10 illustrates a flowchart related to determination model generation processing in the model generation device 7.

Step S11: The dataset acquisition unit 71 acquires a dataset and stores the dataset in the dataset storage unit 73. The dataset acquisition unit 71 preferably sets the image data acquired by the imaging unit 12 as input data of the dataset. The dataset acquisition unit 71 receives an input from the operator for output data corresponding to the image data set as input data. The dataset storage unit 73 may store in advance list data of the state of the treatment unit 10, the state of the fluid, and the control signal that can be selected as the output data of the dataset, and the dataset acquisition unit 71 may determine a dataset by receiving a selection of the output data corresponding to the image data from the list data.

Step S12: The model generation unit 72 executes machine learning processing of the model using the dataset stored in the dataset storage unit 73. The number of datasets used in the machine learning processing is not particularly limited.

Step S13: The model generation unit 72 generates a determination model by completing the machine learning processing in step S12, stores the determination model in the model storage unit 74, and the processing ends.

The determination model stored in the model storage unit 74 is stored in the storage unit DB of the filtration system 1, and thus the determination unit 13 can determine the state of the treatment unit 10 based on the image data using the determination model.

A plurality of determination models may be generated according to a type of fluid such as the slurry liquid, the filtration aid liquid, and the cleaning liquid used in the filtration system 1 and a type of filtration device. The control panel 60 can determine a determination model to be used by the determination unit 13 from among the plurality of determination models stored in the storage unit DB by receiving an input of an instruction related to the type of fluid or filtration device.

The output unit 14 outputs a control signal for the treatment unit 10 based on a determination result of the state of the treatment unit 10 by the determination unit 13. The output unit 14 outputs a control signal based on a control signal table indicating a correspondence relationship between the determination result of the state of the treatment unit 10 and the control signal for the treatment unit 10.

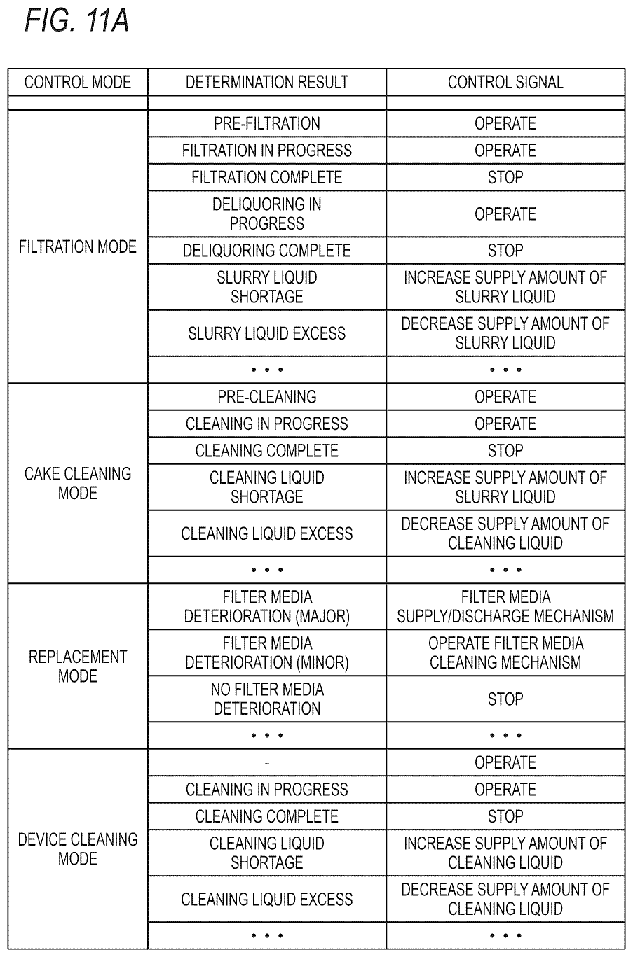

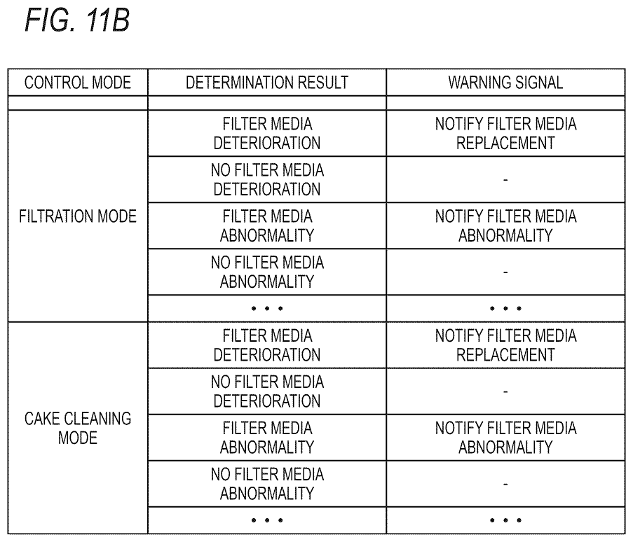

(a) of FIG. 11 illustrates a data configuration example of the control signal table. The control signal table includes a control mode, a determination result, and a control signal. The control signal table illustrated in (a) of FIG. 11 illustrates the determination results by the determination model machine-learned using the dataset in (a) of FIG. 9 and the control signals corresponding thereto. The control signal table may illustrate the determination results related to the state of the fluid by the determination model machine-learned using the dataset in (b) of FIG. 9 and the control signals corresponding thereto. The control signal table can be omitted when the determination model machine-learned using the dataset in (c) of FIG. 9 is used, and the output unit 14 outputs a control signal, which is a determination result by the determination unit 13, to the treatment unit 10.

The control mode indicates which treatment the filtration system 1 is performing: the filtration unit 20, the cleaning unit 30, or the replacement unit 40. The control mode includes a filtration mode related to a control of the filtration unit 20, a cake cleaning mode related to a control of cake cleaning in the cleaning unit 30, a replacement mode related to a control of the replacement unit 40, and a device cleaning mode related to a control of device cleaning in the cleaning unit 30.

The filtration mode may be further classified into a filtration mode and a filtrate deliquoring mode. The cake cleaning mode may be further classified into a cake cleaning mode and a cleaning liquid deliquoring mode. The replacement mode may be further classified into a filter media replacement mode and a filter media cleaning mode.

The control signal indicates a signal for controlling the treatment unit 10 corresponding to the control mode. A plurality of control signals may be set for one determination result. For example, the control signals related to an operation of the filtration unit 20 corresponding to a determination result of filtration complete may include a control signal for controlling the internal pressure of the filter chamber by the filter chamber pressure control unit and a control signal for controlling the opening and closing time of the supply valve of the slurry liquid or the filtration aid liquid.

The control signal for the filtration mode corresponds to the determination result of the treatment state of the filtration unit 20, and includes control signals related to an operation/stop of the filtration unit 20, an increase/decrease in the supply amount of the slurry liquid, an increase/decrease in the supply amount of the filtration aid liquid, an operation/stop of the cake deliquoring treatment, and the like. When the filtration unit 20 receives a control signal output from the output unit 14, the filtration unit 20 controls the filter chamber pressure control unit, a supply valve of the slurry liquid supply tank or the filtration aid liquid supply tank, or the like.

Specifically, the filter chamber pressure control unit controls the operation/stop of the filtration unit 20 and the operation/stop of the cake deliquoring treatment by increasing or decreasing the internal pressure of the filter chamber on at least any one of the supply path side or the discharge path side. The supply valve of the slurry liquid supply tank or the filtration aid liquid supply tank controls the supply amount of the slurry liquid or the filtration aid liquid by changing the opening and closing time of the supply valve.

The control signal for the cake cleaning mode corresponds to the treatment state of the cleaning unit 30, and includes signals for controlling an operation/stop of the cleaning unit 30, an increase/decrease in the supply amount of the cleaning liquid, an operation/stop of the cake deliquoring treatment, and the like. When the cleaning unit 30 acquires the control signal output from the output unit 14, the cleaning unit 30 controls the filter chamber pressure control unit, the supply valve of the cleaning liquid supply tank, and the like.

Specifically, the filter chamber pressure control unit controls the operation/stop of the cleaning unit 30 and the operation/stop of the cake deliquoring treatment by increasing or decreasing the internal pressure of the filter chamber on at least any one of the supply path side or the discharge path side. The supply valve of the cleaning liquid supply tank controls the supply amount of the cleaning liquid by changing the opening and closing time of the supply valve.

The control signal for the replacement mode corresponds to the deterioration state of the filter media, and includes signals for controlling an operation and a stop of the replacement unit 40. When the replacement unit 40 acquires the control signal output from the output unit 14, the replacement unit 40 controls the filter media cleaning mechanism, the filter media supply mechanism, or the filter media discharge mechanism. The control signal for the replacement mode can be set as a control signal for a different mechanism according to a degree of the deterioration state of the filter media. The deterioration state of the filter media may be determined in the filtration mode or the cake cleaning mode, and the mode may be switched to the replacement mode according to the determination result.

The control signal for the device cleaning mode corresponds to the treatment state of the cleaning unit 30, and includes signals for controlling the operation continuation or stop of the cleaning unit 30, the increase/decrease in the supply amount of the cleaning liquid, and the like. A control signal for starting device cleaning in the cleaning unit 30 in the device cleaning mode is output from the output unit 14 by receiving a device cleaning instruction operation from the control panel 60. When the cleaning unit 30 acquires the control signal output from the output unit 14, the cleaning unit 30 controls the filter chamber pressure control unit, the supply valve of the cleaning liquid supply tank, and the like. The device cleaning instruction operation is performed by the operator when replacing an object such as a slurry liquid to be filtered by the filtration system 1.

The output unit 14 outputs a warning signal for the warning notification unit 50 based on the determination result of the state of the treatment unit 10 by the determination unit 13. (b) of FIG. 11 illustrates a data configuration example of a warning signal table. The warning signal table includes a control mode, a determination result, and a warning signal. The control mode in the warning signal table is either the filtration mode or the cake cleaning mode, and a warning signal corresponding to each control mode is set.

The warning signal corresponds to the deterioration state of the filter media or the abnormal state of the filter media, and includes a signal for controlling a warning notification of the warning notification unit 50. When the warning notification unit 50 acquires the warning signal output from the output unit 14, the warning notification unit 50 controls a display on the control panel 60, a voice or an alarm sound of the alarm, lighting of the lamp, and the like.

Specifically, when the control panel 60 acquires a warning signal indicating that there is a filter media abnormality, the control panel 60 displays a notification related to the abnormality. In addition, when the control panel 60 acquires a warning signal indicating that there is filter media deterioration, the control panel 60 displays a notification related to the deterioration. The alarm or the lamp may issue a warning related to the abnormality or deterioration by a voice or a lighting pattern according to the warning signal.

The output unit 14 may output a control signal for stopping the filtration unit 20 or the cleaning unit 30 in response to the determination result of the abnormal state of the filter media. Accordingly, an emergency stop operation in response to an abnormality such as filter media damage can be automated.

The first control mode switching unit 15 switches the control mode indicated in the treatment unit 10 to be controlled in the filtration system 1. The first control mode switching unit 15 determines which control mode to switch to, among the filtration mode, the cake cleaning mode, or the replacement mode, based on the determination result of the state of the treatment unit 10 in the determination unit 13 or the output of the control signal in the output unit 14. The first control mode switching unit 15 normally switches the filtration mode, the cake cleaning mode, and the replacement mode in order. However, for example, when a determination result of the deterioration state or the abnormal state of the filter media is obtained filtration in progress, the filtration mode can be switched to the replacement mode.

The first control mode switching unit 15 switches to the next control mode based on a determination result of the state of filtration complete, cleaning complete, or filter media replacement complete. The first control mode switching unit 15 switches to the next control mode based on an output of a predetermined control signal such as stopping the operation of the filtration unit 20, stopping the operation of the cleaning unit 30, or stopping the operation of the replacement unit 40.

The first control mode switching unit 15 may switch the control mode to the warning notification mode based on the determination result of the abnormal state of the filter media. When the abnormal state is resolved, the first control mode switching unit 15 switches the warning notification mode to the original control mode.

The first control mode switching unit 15 switches the control mode to the device cleaning mode by receiving a device cleaning instruction operation from the control panel 60. The first control mode switching unit 15 switches to the original control mode based on a determination result of the cleaning complete or an output of a control signal to stop operation.

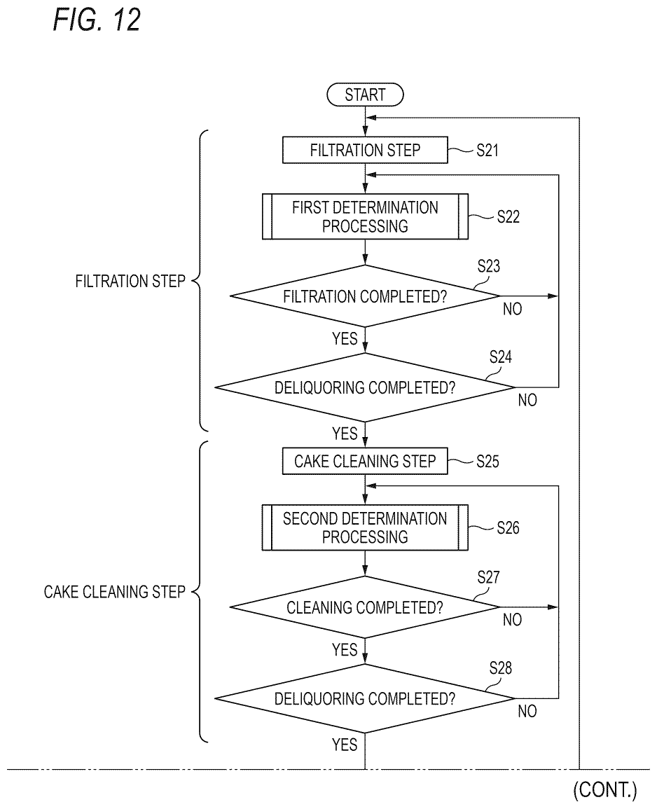

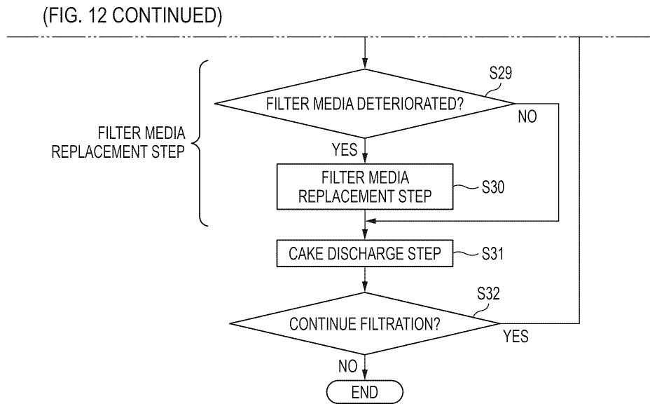

FIG. 12 illustrates a flowchart related to a series of controls by the filtration system 1. The filtration system 1 receives, via the control panel 60, inputs of basic settings such as a type, a total amount, or an operation time of the slurry liquid to be filtered and a type of the filter media to be used, and the processing starts.

### <Filtration Step>

Step S21: The filtration unit 20 performs the filtration treatment by controlling the filter chamber pressure control unit, the slurry liquid supply valve, and the filtration aid liquid supply valve. At this time, the control mode is set to the filtration mode.

Step S22: The imaging unit 12 acquires image data of each of the slurry liquid and the filtrate. The determination unit 13 inputs the image data to the determination model, and determines the state of the treatment unit 10, including the treatment state of the filtration unit 20, the deterioration state of the filter media, and the abnormal state of the filter media. The output unit 14 outputs a control signal for controlling the supply amounts of the slurry liquid and the filtrate to the filtration unit 20 based on a determination result related to the supply amounts of the slurry liquid and the filtrate, and causes the filtration treatment to continue.

Step S23: When the determination unit 13 determines that the filtration treatment state is filtration complete (YES in S23), the output unit 14 outputs a control signal for stopping the operation related to the filtration treatment to the filtration unit 20. The first control mode switching unit 15 switches the control mode to the filtrate deliquoring mode. When the determination unit 13 determines that the filtration treatment state is filtration in progress (NO in S23), the determination unit 13 repeatedly executes first determination processing in step S22 until it is determined that the filtration treatment state is filtration complete.

Step S24: When the determination unit 13 determines that the deliquoring treatment state is deliquoring complete (YES in S24), the output unit 14 outputs a control signal for stopping the operation related to the deliquoring treatment to the filtration unit 20. The first control mode switching unit 15 switches the control mode to the cake cleaning mode. When the determination unit 13 determines that the deliquoring treatment state is deliquoring in progress (NO in S24), the determination unit 13 repeatedly executes the first determination processing in step S22 until it is determined that the deliquoring treatment state is deliquoring complete.

### <Cake Cleaning Step>

Step S25: The cleaning unit 30 performs the cake cleaning treatment by controlling the filter chamber pressure control unit and the cleaning liquid supply valve.

Step S26: The imaging unit 12 acquires image data of the cleaning effluent. The determination unit 13 inputs the image data to the determination model, and determines the state of the treatment unit 10, including the treatment state of the cleaning unit 30, the deterioration state of the filter media, and the abnormal state of the filter media. The output unit 14 outputs a control signal for controlling the supply amount of the cleaning liquid to the cleaning unit 30 based on a determination result related to the supply amount of the cleaning liquid, and causes the cleaning treatment to continue.

Step S27: When the determination unit 13 determines that the treatment state of the cleaning unit 30 is cleaning complete (YES in S27), the output unit 14 outputs a control signal for stopping the operation related to the cleaning treatment to the cleaning unit 30. The first control mode switching unit 15 switches the control mode to the cleaning liquid deliquoring mode. When the determination unit 13 determines that the treatment state of the cleaning unit 30 is cleaning in progress (NO in S27), the determination unit 13 repeatedly executes second determination processing in step S26 until it is determined that the treatment state of the cleaning unit 30 is cleaning complete.

Step S28: When the determination unit 13 determines that the deliquoring treatment state is deliquoring complete (YES in S28), the output unit 14 outputs a control signal for stopping the operation related to the deliquoring treatment to the cleaning unit 30. The first control mode switching unit 15 switches the control mode to the replacement mode. When the determination unit 13 determines that the deliquoring treatment state is deliquoring in progress (NO in S28), the determination unit 13 repeatedly executes the second determination processing in step S26 until it is determined that the deliquoring treatment state is deliquoring complete.

### <Filter Media Replacement Step>

Step S29: The determination unit 13 determines whether the deterioration state of the filter media is filter media deterioration in the filtration step or the cake cleaning step. When the determination unit 13 determines that the deterioration state of the filter media is no filter media deterioration (NO in S29), the filter media replacement is unnecessary and the filter media replacement step is completed.

Step S30: When the determination unit 13 determines that the deterioration state of the filter media is filter media deterioration (YES in S29), the output unit 14 outputs a control signal related to the operation of the replacement unit 40 to the replacement unit 40, the filter media is replaced or the filter media is cleaned. Whether to replace the filter media or clean the filter media is determined by the degree of deterioration state of the filter media. The first control mode switching unit 15 switches the control mode to the filtration mode and the processing is completed. When the determination unit 13 determines that the deterioration state of the filter media is filter media deterioration in the filtration step or the cake cleaning step, step S30 may be immediately executed.

Step S31: After the filter media replacement step, the filtration system 1 performs a cake discharge step of discharging a cake accumulated on the filter media. The cake discharge step may be omitted when the cake is discharged together with the discharge of the filter media in the filter media replacement step.

Step S32: When the cake discharge treatment is completed, the first control mode switching unit 15 switches the control mode to the filtration mode, the filtration system 1 returns to step S21 again, and can repeatedly execute the processing from the filtration step (YES in S32). When the filtration system 1 receives an input of an instruction to complete the filtration or completes a predetermined filtration treatment, the processing ends (NO in S32).

As described above, according to the present disclosure, a series of treatments for filtering a slurry liquid by a filtration device can be automatically controlled.

The filtration system 1 can reduce an operation load by automatically controlling the series of treatments. Further, safety risks can be reduced by preventing poor cleaning when handling chemicals. Further, product quality can be improved by preventing poor deliquoring, maintaining clarity of filtrate, and preventing poor cake cleaning. Further, energy loss can be reduced by preventing excessive liquid deliquoring operation. Further, resource usage can be reduced by preventing excessive cake cleaning and excessive device cleaning.

### Embodiment 2

Hereinafter, a different Embodiment 2 of the filtration system 1 will be described. The same components as those in Embodiment 1 are denoted by the same reference numerals, and the description thereof will be omitted.

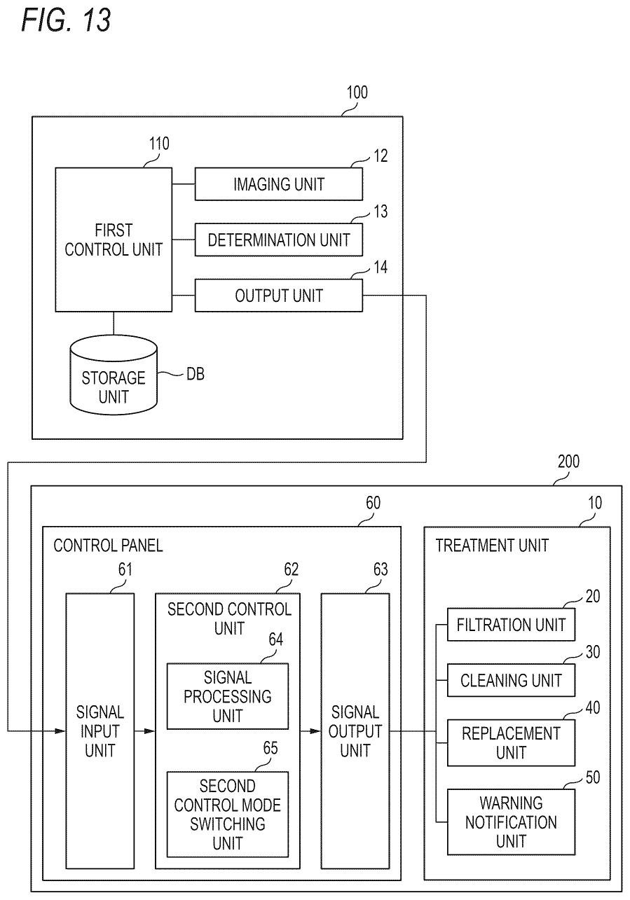

FIG. 13 illustrates a block diagram of a filtration system 1 according to Embodiment 2. In Embodiment 2, the filtration system 1 includes a determination device 100 and a filtration device 200.

The determination device 100 includes a first control unit 110, the imaging unit 12, the determination unit 13, the output unit 14, and the storage unit DB as a database, and each component is connected to and controlled by the first control unit 110. In the present embodiment, the output unit 14 is connected to the filtration device 200 and controls an operation of the filtration device 200 by outputting a control signal.

The imaging unit 12 is disposed on a fluid path in the filtration device 200 and acquires image data of a fluid.

The determination unit 13 determines a state of the treatment unit 10 in the filtration device 200 based on the image data acquired by the imaging unit 12.

In Embodiment 2, the output unit 14 outputs a control signal for the filtration device 200 based on a determination result of the state of the treatment unit 10 by the determination unit 13. The treatment unit 10 is controlled based on the control signal output by the output unit 14.

The determination device 100 may be a general-purpose computer. The determination device 100 includes, as hardware components, an arithmetic device such as a CPU, a main storage device such as a RAM, an auxiliary storage device, a communication device, an input and output device, and the like.

The filtration device 200 includes the control panel 60 and the treatment unit 10. In Embodiment 2, the filtration device 200 may be an existing filtration device. The control panel 60 may be a programmable logic controller (PLC) or the like.

The control panel 60 includes a signal input unit 61, a second control unit 62, and a signal output unit 63. The signal input unit 61 receives an input of a control signal output from the output unit 14 of the determination device 100. The second control unit 62 includes a signal processing unit 64 and a second control mode switching unit 65 as functional components, and executes processing based on the control signal received as input by the signal input unit 61. The signal output unit 63 is connected to the treatment unit 10, acquires a control signal as a processing result by the second control unit 62, and controls an operation of the treatment unit 10 by outputting the control signal to the treatment unit 10.

The signal processing unit 64 acquires the control signal of the output unit 14 and executes signal processing. The signal processing includes processing of converting a control signal into a signal to be output to the treatment unit 10 and processing of determining an output destination.

The second control mode switching unit 65 switches the control mode indicated in the treatment unit 10 to be controlled in the filtration device 200. The second control mode switching unit 65 switches the control mode based on a determination result of the state of the treatment unit 10 by the determination unit 13 or an output of the control signal by the signal output unit 63. The second control mode switching unit 65 may output the switched control mode to the determination device 100.

Similarly to Embodiment 1, the treatment unit 10 includes the filtration unit 20 that controls the filtration step, the cleaning unit 30 that controls the cleaning step, the replacement unit 40 that controls the filter media replacement step, and the warning notification unit 50 that controls the notification on the deterioration state of the filter media or the abnormal state of the filter media. The operations of the filtration unit 20, the cleaning unit 30, the replacement unit 40, and the warning notification unit 50 are controlled based on the control signal output from the signal output unit 63.

The filtration system 1 is not limited to the above embodiment as long as the same operation and effect can be achieved as a whole, and various configurations can be used.

### INDUSTRIAL APPLICABILITY

The present invention can be used in various filtration devices such as a pressure filtration device, a vacuum filtration device, a centrifugal filtration device, and a gravity filtration device.

### REFERENCE SIGNS LIST

1: filtration system
7: model generation device
11: control unit
12: imaging unit
13: determination unit
14: output unit
15: first control mode switching unit
20: filtration unit
30: cleaning unit
40: replacement unit
50: warning notification unit
60: control panel
DB: storage unit
100: determination device
110: first control unit
200: filtration device
61: signal input unit
62: second control unit
63: signal output unit
64: signal processing unit
65: second control mode switching unit
F: fluid
F1: slurry liquid
F2: filtrate
F3: filtration aid liquid
F4: filtrate containing filtration aid liquid
F5: mixed liquid
F6: cleaning liquid
F7: cleaning effluent

1. A filtration system capable of automatically controlling a treatment unit for filtering a slurry liquid, the treatment unit including a filtration unit, the filtration system comprising:
an imaging unit disposed on a path of a fluid in the filtration unit and configured to acquire image data of the fluid;
a determination unit configured to determine a state of the treatment unit based on the image data; and
an output unit configured to output a control signal for the treatment unit based on a determination result of the state of the treatment unit, wherein
the state of the treatment unit includes a treatment state of the filtration unit, a deterioration state of filter media, or an abnormal state of the filter media, and
the determination unit determines a treatment state of the filtration unit, a deterioration state of the filter media, or an abnormal state of the filter media by using a determination model that is machine-learned using the image data as input data and using the treatment state of the filtration unit, the deterioration state of the filter media, or the abnormal state of the filter media as output data.

2. A filtration system capable of automatically controlling a treatment unit for filtering a slurry liquid, the treatment unit including a cleaning unit, the filtration system comprising:
an imaging unit disposed on a path of a fluid in the cleaning unit and configured to acquire image data of the fluid;
a determination unit configured to determine a state of the treatment unit based on the image data; and
an output unit configured to output a control signal for the treatment unit based on a determination result of the state of the treatment unit, wherein
the state of the treatment unit includes a treatment state of the cleaning unit, a deterioration state of filter media, or an abnormal state of the filter media, and
the determination unit determines a treatment state of the cleaning unit, a deterioration state of the filter media, or an abnormal state of the filter media by using a determination model that is machine-learned using the image data as input data and using the treatment state of the cleaning unit, the deterioration state of the filter media, or the abnormal state of the filter media as output data.

3. The filtration system according to claim 1, wherein
the treatment unit includes the filtration unit,
the fluid is filtrate,
the determination unit determines a treatment state of the filtration unit, and
the output unit outputs a control signal for the filtration unit based on a determination result of the treatment state of the filtration unit.

4. The filtration system according to claim 3, wherein
the control signal for the filtration unit includes at least any one or more of a control signal related to an operation of the filtration unit, a control signal related to a supply amount of the slurry liquid, a control signal related to a deliquoring treatment, or a control signal related to a supply amount of a filtration aid liquid.

5. The filtration system according to claim 3, wherein
the control signal for the filtration unit is a control signal for increasing or decreasing an internal pressure of a filter chamber on at least any one of a supply path side or a discharge path side.

6. The filtration system according to claim 3, wherein
the control signal for the filtration unit is a control signal for changing an opening and closing time of a supply valve for the slurry liquid or a filtration aid liquid.

7. The filtration system according to claim 2, wherein
the treatment unit includes the cleaning unit,
the fluid is cleaning effluent,
the determination unit determines a treatment state of the cleaning unit, and
the output unit outputs a control signal for the cleaning unit based on a determination result of the treatment state of the cleaning unit.

8. The filtration system according to claim 1, wherein
the treatment unit includes the filtration unit, a cleaning unit, a replacement unit, or a warning notification unit,
the fluid is filtrate,
the determination unit determines a deterioration state of the filter media, and
the output unit outputs at least any one or more of a control signal for the cleaning unit, a control signal for the replacement unit, or a warning signal for the warning notification unit based on a determination result of the deterioration state of the filter media.

9. The filtration system according to claim 2, wherein
the treatment unit includes the cleaning unit, a replacement unit, or a warning notification unit,
the fluid is cleaning effluent,
the determination unit determines a deterioration state of the filter media, and
the output unit outputs at least any one or more of a control signal for the cleaning unit, a control signal for the replacement unit, or a warning signal for the warning notification unit based on a determination result of the deterioration state of the filter media.

10. The filtration system according to claim 1, wherein
the treatment unit includes the filtration unit, the cleaning unit, or a warning notification unit,
the fluid is filtrate or cleaning effluent,
the determination unit determines an abnormal state of the filter media, and
the output unit outputs a control signal related to an operation to the filtration unit or outputs a warning signal related to an abnormal state of the filter media to the warning notification unit, based on a determination result of the abnormal state of the filter media.

11. The filtration system according to claim 1, wherein
the treatment unit includes the filtration unit,
the fluid is the slurry liquid,
the imaging unit is disposed on a supply path of the slurry liquid and acquires image data of the slurry liquid, and
the output unit outputs a control signal related to a supply amount of a filtration aid liquid to the filtration unit based on a determination result of the treatment state of the filtration unit.

12. The filtration system according to claim 1, wherein
the imaging unit is disposed on the path of the fluid at an angle of view that is substantially horizontal with respect to a horizontal plane.

13. The filtration system according to claim 1, further comprising:
a control mode switching unit configured to switch a treatment unit to be controlled, wherein
the treatment unit includes the filtration unit, the cleaning unit, and a replacement unit,
the determination unit determines a state of the treatment unit including the treatment state of the filtration unit, the treatment state of the cleaning unit, and the deterioration state of the filter media,
the output unit outputs a control signal for the filtration unit, the cleaning unit, and the replacement unit based on a determination result of the state of the treatment unit, and
the control mode switching unit switches a control mode based on the determination result of the state of the treatment unit or an output of the control signal.

14. The filtration system according to claim 13, wherein
the treatment unit includes a warning notification unit,
the determination unit further determines a state of the treatment unit including the abnormal state of the filter media, and
the output unit outputs a warning signal corresponding to the control mode to the warning notification unit based on a determination result of the deterioration state of the filter media or the abnormal state of the filter media.

15. The filtration system according to claim 13, wherein
a filtrate discharge path of the filtration unit also serves as a cleaning effluent discharge path of the cleaning unit, and
the imaging unit is disposed in the filtrate discharge path.

16. The filtration system according to claim 2, wherein
the treatment unit includes the filtration unit, the cleaning unit, or a warning notification unit,
the fluid is filtrate or cleaning effluent,
the determination unit determines an abnormal state of the filter media, and
the output unit outputs a control signal related to an operation to the filtration unit or outputs a warning signal related to an abnormal state of the filter media to the warning notification unit, based on a determination result of the abnormal state of the filter media.

17. The filtration system according to claim 2, wherein
the imaging unit is disposed on the path of the fluid at an angle of view that is substantially horizontal with respect to a horizontal plane.

18. The filtration system according to claim 2, further comprising:
a control mode switching unit configured to switch a treatment unit to be controlled, wherein
the treatment unit includes the filtration unit, the cleaning unit, and a replacement unit,
the determination unit determines a state of the treatment unit including the treatment state of the filtration unit, the treatment state of the cleaning unit, and the deterioration state of the filter media,
the output unit outputs a control signal for the filtration unit, the cleaning unit, and the replacement unit based on a determination result of the state of the treatment unit, and
the control mode switching unit switches a control mode based on the determination result of the state of the treatment unit or an output of the control signal.

19. The filtration system according to claim 18, wherein
the treatment unit includes a warning notification unit,
the determination unit further determines a state of the treatment unit including the abnormal state of the filter media, and
the output unit outputs a warning signal corresponding to the control mode to the warning notification unit based on a determination result of the deterioration state of the filter media or the abnormal state of the filter media.

20. The filtration system according to claim 18, wherein
a filtrate discharge path of the filtration unit also serves as a cleaning effluent discharge path of the cleaning unit, and
the imaging unit is disposed in the filtrate discharge path.
